(19) United States
(12) Patent Application Publication
(10) Pub. No.: US 2026/0151975 A1
(43) Pub. Date: Jun. 4, 2026

(54) STORAGE UNIT WITH A FOIL UNIT FOR A TIRE TEST STAND, METHOD FOR MANUFACTURING A STORAGE UNIT AND THE TIRE TEST STAND WITH A STORAGE UNIT

(71) Applicant: ZF Friedrichshafen AG, Friedrichshafen (DE)

(72) Inventors: Roland BÖSL, Neuburg am Inn (DE); Alexander BOEHM, Ruderting (DE)

(73) Assignee: ZF Friedrichshafen AG, Friedrichshafen (DE)

(21) Appl. No.: 19/404,601

(22) Filed: Dec. 1, 2025

(30) Foreign Application Priority Data
Dec. 2, 2024 (DE) 10 2024 211 493.6

(51) Int. Cl. B29D 30/00; F16C 32/06; F16C 43/00

(52) U.S. Cl. CPC B29D 30/0061; F16C 32/0614; F16C 43/00; B29D 2030/0066

(57) ABSTRACT

A bearing unit for a tire test bench has a support unit and a film unit. The support unit has an inlet section defining an inlet opening and multiple outlet sections each defining an outlet opening connected to the inlet opening such that when a pressurized gaseous fluid flows into the inlet opening, the pressurized gaseous fluid flows out of each outlet opening. The film unit has multiple passage sections each defining a passage opening. The support unit and the film unit are arranged so that, for each outlet opening, the outlet opening and an associate passage opening are arranged relative to each other such that, when the pressurized gaseous fluid flows out of the outlet opening, the gaseous fluid flowing out of the outlet opening flows through the associated passage opening. A method and a tire test bench are shown and described.

### RELATED APPLICATIONS

This application claims the benefit of and right of priority under 35 U.S.C. § 119 to German Patent Application no. 10 2024 211 493.6, filed on 2 Dec. 2024, the contents of which are incorporated herein by reference in its entirety.

### FIELD OF THE DISCLOSURE

The present invention relates to a bearing unit for a tire test bench, a method for manufacturing a bearing unit, and a tire test bench with a bearing unit.

### BACKGROUND

Tire test benches are known from the prior art. These tire test benches usually have a frame and a tire holder. A tire with a tread can be mounted on the tire holder so that it can rotate about its axis of rotation. When the tire is rotatably mounted on the tire holder, the tire can be moved into different positions relative to the frame. In the tire test benches known from the prior art, a rolling surface unit with a rolling surface is provided which can be moved relative to the frame. The rolling surface of the rolling surface unit can also be referred to as a road substitute and is intended to approximate the conditions on a road.

### SUMMARY

In general, it is desirable that tire testing can be carried out with a high degree of reliability.

It is therefore the object of the present invention to provide a bearing unit for a tire test bench such that tire testing can be carried out with a high degree of reliability.

According to a first aspect of the invention, the aforementioned task is solved by a bearing unit having the features disclosed herein. The bearing unit is designed for a tire test bench. The bearing unit comprises a support unit and a film unit. The support unit comprises an inlet section that defines an inlet opening and a plurality of outlet sections. Each of the plurality of outlet sections defines an outlet opening. Each outlet opening is connected to the inlet opening such that when a pressurized gaseous fluid flows into the inlet opening, the pressurized gaseous fluid flows out of each outlet opening. The film unit comprises a plurality of passage sections. Each passage section of the plurality of passage sections defines a passage opening. The support unit and the film unit are arranged relative to each other such that, for each outlet opening, the corresponding outlet opening and a passage opening associated with the corresponding outlet opening are arranged relative to each other such that, when the pressurized gaseous fluid flows out of the corresponding outlet opening, the gaseous fluid flowing out of the corresponding outlet opening flows through the passage opening associated with the corresponding outlet opening.

As already described, the bearing unit is designed for a tire test bench. Preferably, the bearing unit comprises a fastening portion with which the bearing unit can be attached to a fastening portion of the tire test bench. Preferably, the fastening portion of the bearing unit can be attached to a fastening portion of a frame of the tire test bench.

As also described above, the bearing unit comprises a support unit and a film unit. The support unit can also be referred to as a carrier. Preferably, the support unit comprises the fastening portion with which the bearing unit can be fastened to the fastening portion of the tire test bench. Alternatively, the support unit is preferably connected to the fastening portion with which the bearing unit can be fastened to the fastening portion of the tire test bench. The film unit can also be referred to as a foil or a sliding film. Preferably, the film unit comprises a surface that faces the environment of the bearing unit. In particular, the film unit can be configured independently of the support unit and can, for example, be adjusted so that the surface of the film unit provides a low coefficient of friction with high abrasion resistance and high temperature resistance, especially in the case where the surface of the film unit comes into contact with a surface of a flat belt section of a belt unit of the tire test bench.

As also described above, the support unit comprises an inlet section that defines an inlet opening and a plurality of outlet sections, wherein each outlet section of the plurality of outlet sections defines an outlet opening. As also described above, each outlet opening is connected to the inlet opening such that when a pressurized gaseous fluid flows into the inlet opening, the pressurized gaseous fluid flows out of each outlet opening. The fact that the support unit comprises the inlet section, which defines the inlet opening, and the plurality of outlet sections, wherein each outlet section of the plurality of outlet sections defines an outlet opening and each outlet opening is connected to the inlet opening such that when a pressurized gaseous fluid flows into the inlet opening, the pressurized gaseous fluid flows out of each outlet opening, ensures that the bearing unit can be used to provide a bearing for guiding the belt unit of the tire test bench in the region of the outlet openings, in particular since the gaseous fluid flowing out of each outlet opening can be used to provide a force acting on the flat belt section, which acts in a direction from the bearing unit towards the flat belt section and towards a tire in contact with the flat belt section.

As already described, the support unit and the film unit are arranged relative to each other such that, for each outlet opening, the corresponding outlet opening and a passage opening associated with the corresponding outlet opening are arranged relative to each other such that, when the pressurized gaseous fluid flows out of the corresponding outlet opening, the gaseous fluid flowing out of the corresponding outlet opening flows through the passage opening associated with the corresponding outlet opening. The fact that the support unit and the film unit are arranged relative to each other such that for each outlet opening, the corresponding outlet opening and a passage opening assigned to the corresponding outlet opening are arranged relative to each other such that when the pressurized gaseous fluid flows out of the corresponding outlet opening, the gaseous fluid flowing out of the corresponding outlet opening flows through the passage opening associated with the corresponding outlet opening, ensures that the bearing unit can be arranged so that the film unit can be located on a side of the support unit facing the flat belt section and, in this arrangement, a bearing for guiding the belt unit can be provided with the aid of the outlet openings, the passage openings, and the gaseous fluid, as well as with the aid of the film unit. The bearing unit provides two functions, meaning that the bearing unit can also be referred to as a hybrid bearing unit. A first function of the two functions is provided by means of the outlet openings, the passage openings, and the gaseous fluid, by providing a bearing for guiding the belt unit in the region of the outlet openings and the passage openings by means of the gaseous fluid flowing out of each outlet opening, a force can be provided on the side of the flat belt section on which the bearing unit is arranged, acting on the flat belt section on this side, which acts in a direction toward a side of the flat belt section opposing this side of the flat belt section, such that a deformation of the flat belt section in a direction toward the side of the flat belt section on which the bearing unit is arranged can be reduced or even completely prevented. If the load on the flat section of the belt caused by different load conditions of a tire attached to a tire holder on the test bench is so high that the flat section of the belt deforms to such an extent that it comes into contact with the bearing unit, the film unit is provided for this contact, which can be designed for contact with the flat belt section independently of the design of the support unit and comprise a surface designed for this contact. A second function of the two functions is provided by means of the film unit, in that a bearing for guiding the belt unit is additionally provided by means of the film unit, in that the surface, which can also be referred to as the contact surface, is provided for contact with the flat belt section, such that an additional force acting on the flat belt section can be provided, which acts on the side of the flat belt section on which the bearing unit is arranged, in a direction toward the flat belt section.

Because the bearing unit can provide a double-acting bearing unit with the aid of the pressurized gaseous fluid and the film unit, particularly large forces can act on the flat belt section with the aid of the bearing unit, such that tire test benches can be operated in the high load range, in particular with wheel loads of more than one ton (wheel loads >1 t), can be operated using the bearing unit, thereby eliminating the need for water bearings. Water bearings often use water to support the flat belt section. Water bearings often have a metal body in which pressurized water emerges from the surface via a large number of small holes and thus gets between a belt unit, in particular a flat belt section of the belt unit, the tire test bench, and this surface. This pressurized water and the resulting water film between the belt unit and the surface described carries the flat belt section as it is guided past the surface, sometimes at high speed. The water used is often collected and drained off and must not get between the belt unit and the deflection pulleys of the tire test bench, because the required friction is reduced there and the belt unit position control fails in extreme cases. If water does get between the belt unit and the pulleys of the tire test bench, the belt unit can no longer transfer the traction and lateral forces of the tire to the pulleys. If water also gets between the belt unit and the tire (spray water, water mist), the measured values determined on the tire will be falsified (the friction between the tire and the belt unit is changed). Scrapers are usually installed around the water bearing. These are used to remove the entire water film and spray water in a controlled manner. Another weakness is the risk of the deflectors being damaged by tire particles sticking to the underside of the belt unit. After intensive testing, some of the deflectors have to be replaced frequently. Compared to water bearings, the bearing unit according to the invention therefore ensures more reliable testing of tires with a simpler and lower-maintenance design compared to water bearings.

The bearing unit according to the invention also offers advantages over counter-bearings that use the medium air and can also be referred to as air bearings. With air bearings, air is often pressed under high pressure (30 bar) between the two parts mounted against each other. Industry-standard air bearings work contact-free. If contact occurs during operation while in motion, this will damage the contact surfaces. However, as long as it can be assumed that the two parts maintain their shape with sufficient accuracy, direct contact can be avoided. Contact between two conventionally designed partners leads to high friction and, in conjunction with high speeds, to high frictional power and therefore high temperatures that damage the surfaces. With wheel loads above one ton and the lateral forces that can be achieved, relevant elastic deformations of the belt unit and in particular of the flat belt section occur. Current tire designs in particular generate high pressure peaks under certain operating conditions. As a result, the belt unit can also experience local deformations and thus come into contact with the components of the air bearing. The mandatory no-contact rule can no longer be implemented in these cases. This has led to the misconception that air bearings can only be used in load ranges up to one ton, with certain types of tires, and with very limited lateral forces. Compared to air bearings, the bearing unit according to the invention ensures that tire test benches can also be operated reliably for load ranges exceeding one ton.

With the bearing unit according to the invention, contact between the bearing unit and the belt unit, in particular the flat belt section, can be deliberately allowed due to the film unit. Tests carried out on the bearing unit according to the invention have shown that even under extreme operating conditions in terms of load, tire air pressure, and lateral forces due to steering, more than 95% of the load is still carried by the pressurized gaseous fluid. In particular, the bearing unit according to the invention can be used to prevent damage to the support unit, which is particularly advantageous in comparison to air bearings, in which only a support unit and no film unit is provided. In particular, the film unit can be used to provide a suitable layer whose surface comprises a low coefficient of friction and high abrasion and temperature resistance, such that the remaining 5% of the load can be absorbed by these local contacts. This means that all common tire types can be tested at high wheel loads. In the event of wear, replacement is simple, quick, and inexpensive. It is not the air bearing itself that is subject to wear, but only the film unit.

In summary, it can therefore be stated that the present invention can be used to test tires in a particularly reliable manner.

In one embodiment, the support unit and the film unit are connected to each other. The fact that the support unit and the film unit are connected to each other provides a particularly simple bearing unit that can be designed to be particularly lightweight, as it is possible to dispense with a plate unit in particular. Preferably, the support unit and the film unit are connected to each other by gluing the film unit to the support unit. Because the film unit is glued to the support unit, it can be replaced very easily. Preferably, the film unit comprises an adhesive layer on one side with which the remaining section of the film unit is coated. The film unit can then also be referred to as a film unit coated on one side with adhesive, wherein the adhesive is a component of the film unit. Preferably, the adhesive layer is formed from the adhesive. Preferably, the adhesive is a pressure-sensitive adhesive. The fact that the adhesive is a pressure-sensitive adhesive ensures that the support unit and the film unit can be bonded particularly easily. Preferably, the adhesive comprises a silicone.

In one embodiment, a plate unit is arranged between the support unit and the film unit, wherein the plate unit and the film unit are connected to each other. The fact that a plate unit is arranged between the support unit and the film unit, wherein the plate unit and the film unit are connected to each other, ensures that the plate unit can be replaced together with the film unit, in particular without having to replace or modify the support unit. Preferably, the plate unit is connected to the support unit on a first side of the plate unit and is connected to the film unit on a second side of the plate unit opposing the first side. If the film unit needs to be replaced, the support unit and the plate unit can be separated from each other and the plate unit can be removed together with the film unit, and a new plate unit, which is also connected to a film unit, can be connected to the support unit. The fact that the plate unit is arranged between the support unit and the film unit, wherein the plate unit and the film unit are connected to each other, significantly simplifies the replacement of the film unit. Preferably, the plate unit and the film unit are connected to each other by gluing the film unit to the plate unit. Because the film unit is glued to the plate unit, the film unit can be connected to and removed from the plate unit with particular ease.

In one embodiment, the support unit comprises a metal or a metal alloy. The fact that the support unit comprises a metal or a metal alloy ensures that a particularly robust support unit is provided. Preferably, the support unit is made of a metal or a metal alloy such that the support unit can be designed to be particularly robust. Preferably, the support unit is made of steel, such that the mechanical robustness of the support unit is optimally adjusted. Preferably, the support unit is made of aluminum, such that the support unit can be designed to be particularly lightweight.

In one embodiment, the film unit comprises a fabric. The fact that the film unit comprises a fabric ensures that the film unit is particularly robust in mechanical terms. Preferably, the fabric extends within a plane in which the film unit extends, such that with the aid of the fabric, the film unit can be designed to be particularly mechanically robust, especially within this plane. Preferably, the fabric is a glass fabric. Because the fabric is a glass fabric, the film unit can be designed to be mechanically robust while remaining lightweight.

In one embodiment, the film unit comprises a polymer. The fact that the film unit comprises a polymer means that a surface with a particularly low coefficient of friction can be provided. Preferably, the film unit comprises a fluoropolymer. The fact that the film unit comprises the fluoropolymer means that a particularly low coefficient of friction is provided. Preferably, the film unit comprises polytetrafluoroethylene (PTFE). The fact that the film unit comprises polytetrafluoroethylene (PTFE) provides a particularly low coefficient of friction. In particular, because the film unit comprises polytetrafluoroethylene (PTFE), the film unit can provide a surface for contact with the belt unit, in particular with the flat belt section, wherein the surface comprises a low coefficient of friction with high abrasion resistance and high temperature resistance. Preferably, the film unit comprises glass fabric and polytetrafluoroethylene (PTFE), wherein the glass fabric is coated with the polytetrafluoroethylene (PTFE). The fact that the film unit comprises a glass fabric and polytetrafluoroethylene (PTFE), wherein the glass fabric is coated with the polytetrafluoroethylene (PTFE), means that the glass fabric can be used to provide mechanical robustness to the film unit, particularly within a plane in which the film unit extends, and the polytetrafluoroethylene (PTFE) can protect the glass fabric and provide the surface for contact with the belt unit, such that the surface can provide a particularly low coefficient of friction with high abrasion resistance and high temperature resistance.

According to a second aspect of the invention, the aforementioned task is solved by a method as disclosed herein. The method is intended for manufacturing a bearing unit according to the first aspect of the invention. The method comprises the following steps:
providing the support unit and the film unit such that the support unit and the film unit are arranged relative to each other such that, for each outlet opening, the corresponding outlet opening and a passage opening associated with the corresponding outlet opening are arranged relative to each other such that, when the pressurized gaseous fluid flows out of the corresponding outlet opening, the gaseous fluid flowing out of the corresponding outlet opening flows through the passage opening associated with the corresponding outlet opening. The fact that the support unit and the film unit are arranged relative to each other such that for each outlet opening, the corresponding outlet opening and a passage opening assigned to the corresponding outlet opening are arranged relative to each other such that when the pressurized gaseous fluid flows out of the corresponding outlet opening, the gaseous fluid flowing out of the corresponding outlet opening flows through the passage opening associated with the corresponding outlet opening, ensures that the bearing unit can be arranged so that the film unit can be located on a side of the support unit facing the flat belt section and, in this arrangement, a bearing for guiding the belt unit can be provided with the aid of the outlet openings, the passage openings, and the gaseous fluid, as well as with the aid of the film unit. The bearing unit provides the two functions already described.

In one embodiment, the film unit is adhered to the support unit in such a way that the support unit and the film unit are arranged relative to each other such that, for each outlet opening, the corresponding outlet opening and a passage opening associated with the corresponding outlet opening are arranged relative to each other such that, when the pressurized gaseous fluid flows out of the corresponding outlet opening, the gaseous fluid flowing out of the corresponding outlet opening flows through the passage opening associated with the corresponding outlet opening. The fact that the film unit is glued to the support unit ensures that the bearing unit can be manufactured particularly easily and quickly and that the film unit can be replaced particularly easily.

The features, technical effects, and/or advantages described in connection with the bearing unit according to the first aspect of the invention apply at least analogously to the method according to the second aspect of the invention, such that a corresponding repetition is omitted here. Even though the method steps are described in a specific order, the present invention is not limited to this order. Rather, the individual method steps can be carried out in any sensible order, in particular also at least in sections parallel to each other in time.

According to a third aspect of the invention, the aforementioned task is solved by a tire test bench with the features disclosed herein. The tire test bench comprises a frame. In addition, the tire test bench comprises a tire holder attached to the frame, on which a tire with a tread can be mounted so that it can rotate about its axis of rotation. The tire test bench also comprises a belt unit. In addition, the tire test bench comprises two pulleys rotatably mounted relative to the frame. The pulleys are partially wrapped around the belt unit such that the belt unit forms a flat belt section between the pulleys. Then, when the tire is rotatably mounted on the tire holder, the tire can be moved to a contact position on a first side of the flat belt section in which the tread of the tire and the flat belt section are in contact. Then, when the tire and the flat belt section are in contact and the belt unit is moved relative to the tire, the tire rolls on the flat belt section. The tire test bench also comprises a bearing unit according to the first aspect of the invention. The bearing unit is arranged on a second side opposite the first side of the flat belt section so that the film unit is arranged on a side of the support unit facing the flat belt section. Each pulley can also be referred to as a drum. The fact that the bearing unit is arranged on the second side of the flat belt section allows the bearing unit to counteract the deformation of the flat belt section in the direction toward the second side of the flat belt section or even prevent deformation of the flat belt section in the direction toward the second side of the flat belt section. The fact that the bearing unit is arranged on the second side of the flat belt section opposing the first side, such that the film unit is arranged on the side of the support unit facing the flat belt section, ensures that the film unit is intended to come into contact with the flat belt section and that the film unit protects the support unit from coming into contact with the flat belt section. This means that the film unit can be specifically designed for contact with the flat belt section, and if the film unit wears out, it can be renewed or replaced and the support unit can continue to be used, thereby providing a particularly resource-efficient bearing unit and a particularly resource-efficient tire test bench.

In one embodiment, the belt unit comprises a metal or a metal alloy. The fact that the belt unit comprises a metal or metal alloy ensures that the belt unit is particularly robust in mechanical terms. Preferably, the belt unit is made of steel, which ensures that the belt unit is only slightly deformed under different load conditions of the tire. This allows tires to be subjected to particularly high mechanical loads using the tire test bench. If the belt unit is made of steel, the belt unit can also be referred to as a steel belt.

The features, technical effects, and/or advantages described in connection with the bearing unit according to the first aspect of the invention and the features, technical effects, and/or advantages described in connection with the method according to the second aspect of the invention apply at least analogously to the tire test bench according to the third aspect of the invention, such that a corresponding repetition is omitted here.

It has been found that the bearing unit according to the first aspect of the present invention offers the following advantages over water bearings known from the prior art: the bearing unit according to the first aspect of the present invention eliminates the need for scrapers (including conditioning, adjustment, replacement, etc.). The bearing unit according to the first aspect of the present invention eliminates the risk of measurement distortion due to spray water. The bearing unit according to the first aspect of the present invention eliminates the risk of belt unit bearing control failure due to friction loss between the belt unit and the pulleys. The bearing unit according to the first aspect of the present invention significantly reduces the risk of corrosion of components of the bearing unit and the risk of corrosion of components of the tire test bench. The bearing unit according to the first aspect of the present invention prevents tire particles from mixing with water (contamination of the system). The bearing unit according to the first aspect of the present invention eliminates the need to replace used water (odor nuisance). The bearing unit according to the first aspect of the present invention eliminates the need for a pressurized water system.

It has been found that the bearing unit according to the first aspect of the present invention offers the following advantages over air bearings known from the prior art: Using the bearing unit according to the first aspect of the present invention, high wheel and lateral forces can be reliably controlled. Using the bearing unit according to the first aspect of the present invention, the costs of the sliding film are low. Using the bearing unit according to the first aspect of the present invention, very quick and easy replacement of the sliding film and thus a short downtime of the system is ensured. Using the bearing unit according to the first aspect of the present invention, a very short downtime of the system in the event of damage and repair is ensured.

### BRIEF DESCRIPTION OF THE DRAWINGS

Further features, advantages, and possible applications of the present invention are apparent from the following description of the exemplary embodiments and the figures. All features described and/or illustrated, individually and in any combination, form the subject matter of the invention, regardless of their composition in the individual claims or their references. In the figures, identical reference numerals refer to identical or similar objects.

FIG. 1 shows a schematic illustration of an embodiment of a tire test bench according to the invention,

FIG. 2 shows a schematic illustration of an embodiment of a bearing unit according to the invention, and

FIG. 3 shows a schematic illustration of an embodiment of a method according to the invention for manufacturing the embodiment of the bearing unit according to the invention shown schematically in FIG. 2.

### DETAILED DESCRIPTION

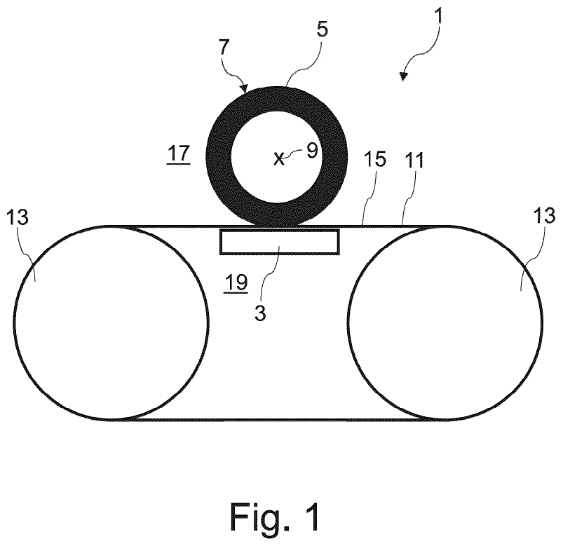

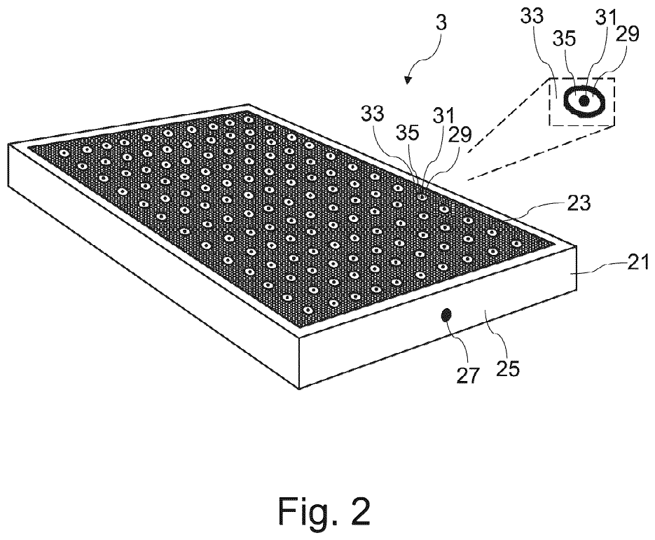

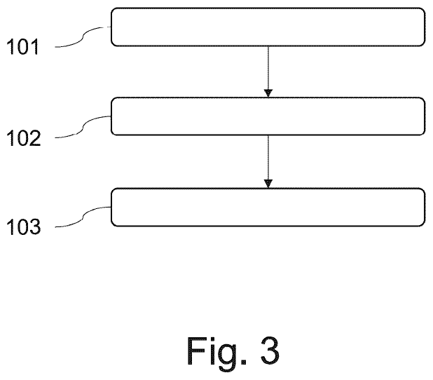

FIG. 1 shows a schematic illustration of an embodiment of a tire test bench 1 according to the invention. FIG. 2 shows a schematic illustration of an embodiment of a bearing unit 3 according to the invention, and FIG. 3 shows a schematic illustration of an embodiment of a method according to the invention for manufacturing the embodiment of the bearing unit 3 according to the invention schematically shown in FIG. 2.

The tire test bench 1 comprises a frame not shown. In addition, the tire test bench 1 comprises a tire holder attached to the frame, which is also not shown, A tire 5 with a tread 7 can be mounted on the tire holder so that it can rotate about its axis of rotation 9. In addition, the tire test bench 1 comprises a belt unit 11. In addition, the tire test bench 1 comprises two pulleys rotatably mounted opposite the frame. Each pulley 13 of the pulleys is partially wrapped by the belt unit 11. The pulleys are therefore partially wrapped by the belt unit 11. The pulleys are partially wrapped by the belt unit 11 in such a way that the belt unit 11 forms a flat belt section 15 between the pulleys. Then, when the tire 5 is rotatably mounted on the tire holder, the tire 5 can be moved on a first side 17 of the flat belt section 15 into a contact position shown in FIG. 1, in which the tread 7 of the tire 5 and the flat belt section 15 are in contact. The tire test bench 1 comprises a belt drive unit (not shown). The belt drive unit can drive the belt unit 11 in a belt rotation direction. The belt drive unit is coupled to a pulley 13 of the pulleys to drive the belt unit 11 via this pulley 13 in the belt rotation direction. When the tire 5 and the flat belt section 15 are in contact and the belt unit 11 is moved relative to the tire 5, the tire 5 rolls on the flat belt section 15. The tire test bench 1 also comprises the bearing unit 3. The bearing unit 3 is arranged on a second side 19 of the flat belt section 15 opposing the first side 17.

The tire 5 can be positioned in relation to the flat belt section 15. In particular, the tire 5 can be brought into the contact position, in which the tread 7 of the tire 5 is in contact with the flat belt section 15, by adjusting a drive element or by adjusting several drive elements. Furthermore, the tire 5 can be moved to other contact positions by adjusting a drive element or by adjusting multiple drive elements next to the contact position, in which the tread 7 of the tire 5 is also in contact with the flat belt section 15. When the tire 5 rolls on the flat belt section 15, the tire 5 is subjected to different load conditions as it rolls. By adjusting the drive element or the multiple drive elements, the camber of the tire 5, the skew of the tire 5, the tire load of the tire 5, and/or the position of the tire 5 relative to the flat belt section 15 can be adjusted as the tire 5 rolls on the flat belt section 15. In addition, the tire 5 can be driven in a tire rotation direction using a tire drive unit of the tire test bench 1 or braked in the tire rotation direction using a tire braking unit. This allows the tire 5 to be subjected to different load conditions during rolling. In each load condition of the tire 5, different reaction forces act on the tire 5, which can be detected by a detection unit of the tire test bench 1. Since the

tire 5 rolls on the flat belt section 15, it is ensured that a situation in which the tire 5 rolls on a real road can be simulated particularly well. In each load condition of the tire 5, reaction forces do not only act on the tire 5. Rather, forces also act on the belt unit 11 and, in particular, on the flat belt section 15 in the different load conditions. These forces can, for example, cause the flat belt section 15 to deform in a direction toward the second side 19 of the flat belt section 15. The bearing unit 3 is arranged on the second side 19 of the flat belt section 15 and can thus counteract the deformation of the flat belt section 15 in the direction towards the second side 19 of the flat belt section 15 or even prevent deformation of the flat belt section 15 in the direction towards the second side 19 of the flat belt section 15.

The bearing unit 3 is designed for the tire test bench 1. The bearing unit 3 comprises a fastening portion with which the bearing unit 3 can be attached to a fastening portion of the tire test bench 1. In the exemplary embodiment of the tire test bench 1 shown in FIG. 1, the fastening portion of the bearing unit 3 can be fastened to a fastening portion of the frame of the tire test bench 1.

The bearing unit 3 comprises a support unit 21 and a film unit 23. The support unit 21 comprises an inlet section 25 and a plurality of outlet sections. The inlet section 25 defines an inlet opening 27. Each outlet section 29 of the plurality of outlet sections defines an outlet opening 31. In the embodiment of the bearing unit 3 according to the invention shown schematically in FIGS. 2, 130 outlet sections and 130 outlet openings are shown schematically as examples. Each outlet opening 31 is connected to the inlet opening 27 such that, when a pressurized gaseous fluid flows into the inlet opening 27, the pressurized gaseous fluid flows out of each outlet opening 31. The fact that each outlet opening 31 is connected to the inlet opening 27 such that, when the pressurized gaseous fluid flows into the inlet opening 27, the pressurized gaseous fluid flows out of each outlet opening 31, it is ensured that, with the aid of the bearing unit 3, a bearing for guiding the belt unit 11 can be provided in the region of the outlet openings, in particular since, with the aid of the gaseous fluid flowing out of each outlet opening 31, a force can be provided on the second side 19 of the flat belt section 15, which acts on the flat belt section 15 on the second side 19 in a direction towards the first side 17 of the flat belt section 15. Channels are provided in the support unit 21, which connect the inlet opening 27 and the outlet openings to each other, such that the pressurized fluid can flow into the inlet opening 27 and out of each outlet opening 31. The tire test bench I comprises a compressor unit that can be connected to the inlet opening 27 and which provides the pressurized gaseous fluid. Tire test bench 1 is equipped with a compressor unit that supplies air as a gaseous fluid, allowing the tire test bench 1 to be constructed in a particularly simple manner. Using the bearing unit 3, an air bearing can thus be provided in the region of the outlet openings to guide the belt unit 11, wherein the bearing unit 3 differs from air bearings known from the prior art, which will be discussed in more detail below.

The film unit 23 comprises a plurality of passage sections. Each passage section 33 of the plurality of passage sections defines a passage opening 35. In the embodiment of the bearing unit 3 according to the invention shown schematically in FIGS. 2, 130 passage sections and 130 passage openings are shown schematically by way of example. The support unit 21 and the film unit 23 are arranged relative to each other such that for each outlet opening 31, the corresponding outlet opening 31 and a passage opening 35 associated with the corresponding outlet opening 31 are arranged relative to each other such that, when the pressurized gaseous fluid flows out of the corresponding outlet opening 31, the gaseous fluid flowing out of the corresponding outlet opening 31 flows through the passage opening 35 associated with the corresponding outlet opening 31. The fact that the support unit 21 and the film unit 23 are arranged relative to each other such that for each outlet opening 31, the corresponding outlet opening 31 and a passage opening 35 assigned to the corresponding outlet opening 31 are arranged relative to each other such that, when the pressurized gaseous fluid flows out of the corresponding outlet opening 31, the gaseous fluid flowing out of the corresponding outlet opening 31 flows through the passage opening 35 associated with the corresponding outlet opening 31, ensures that the bearing unit 3 can be arranged so that the film unit 23 can be arranged on a side of the support unit 21 facing the flat belt section 15 and that the bearing unit 3 can be arranged such that, in this arrangement, a bearing for guiding the belt unit 11 can be provided with the aid of the outlet openings, the passage openings, and the gaseous fluid, as well as with the aid of the film unit 23. The bearing unit 3 provides two functions, meaning that the bearing unit 3 can also be referred to as a hybrid bearing unit. A first function of the two functions is provided by means of the outlet openings, the passage openings, and the gaseous fluid, by providing a bearing for guiding the belt unit 11 in the region of the outlet openings and the passage openings by using the gaseous fluid flowing out of each outlet opening 31 to provide a force on the second side 19 of the flat belt section 15, which acts on the flat belt section 15 on the second side 19 which acts in a direction toward the first side 17 of the flat belt section 15, such that deformation of the flat belt section 15 in a direction toward the second side 19 of the flat belt section 15 is reduced or even completely prevented. If the load on the flat belt section 15 due to different load conditions of the tire 5 is so high that the flat belt section 15 deforms to such an extent that it comes into contact with the bearing unit 3, the film unit 23 is provided for this contact, which can be designed for contact with the flat belt section 15 independently of the design of the support unit 21. A second function of the two functions is provided by means of the film unit 23, in that, in addition, a bearing for guiding the belt unit 11 is provided by means of the film unit 23, in that a contact surface for contact with the flat belt section 15 is provided by means of the film unit 23, such that an additional force acting on the flat belt section 15 on the second side 19 can be provided, which acts in a direction toward the first side 17 of the flat belt section 15.

In the embodiment of the bearing unit 3 according to the invention shown schematically in FIG. 2, the support unit 21 and the film unit 23 are connected to each other. The fact that the support unit 21 and the film unit 23 are connected to each other provides a bearing unit 3 with a particularly simple design, which can be made particularly lightweight, since, in particular, a plate unit can be dispensed with. As already described, the support unit 21 and the film unit 23 are connected to each other, which is ensured in the embodiment of the bearing unit 3 according to the invention schematically shown in FIG. 2 by the fact that the film unit 23 is glued to the support unit 21. Because the film unit 23 is glued to the support unit 21, the film unit 23 can be replaced particularly easily.

In an alternative embodiment of the bearing unit 3 according to the invention, a plate unit is arranged between the support unit 21 and the film unit 23, wherein the plate unit and the film unit 23 are connected to each other. The fact that a plate unit is arranged between the support unit 21 and the film unit 23, wherein the plate unit and the film unit 23 are connected to each other, ensures that the plate unit can be replaced together with the film unit 23, in particular without the support unit 21 having to be replaced or machined. In the alternative embodiment of the bearing unit 3 according to the invention, the plate unit is connected to the support unit 21 on a first side of the plate unit and is connected to the film unit 23 on a second side of the plate unit opposing the first side. If the film unit 23 needs to be replaced, the support unit 21 and the plate unit can be separated from each other and the plate unit can be removed together with the film unit 23, and a new plate unit, which is also connected to a film unit 23, can be connected to the support unit 21. The fact that the plate unit is arranged between the support unit 21 and the film unit 23, wherein the plate unit and the film unit 23 are connected to each other, significantly simplifies the replacement of the film unit 23. As already described, the plate unit and the film unit 23 are connected to each other, which is ensured in the alternative embodiment of the bearing unit 3 according to the invention by the fact that the film unit 23 is glued to the plate unit. The fact that the film unit 23 is glued to the plate unit makes it particularly easy to connect the film unit 23 to the plate unit and remove it again from the plate unit.

Like the film unit 23, the plate unit also comprises a plurality of passage sections. Each passage section defines a passage opening. For example, 130 passage sections and 130 passage openings may be provided. The support unit 21, the film unit 23, and the plate unit are arranged relative to each other such that for each outlet opening 31, the corresponding outlet opening 31, a passage opening of a corresponding passage section of the plate unit assigned to the corresponding outlet opening 31 and a passage opening 35 of a corresponding passage section 33 of the film unit 23 assigned to the corresponding outlet opening 31 are arranged relative to each other in such a way that, when the pressurized gaseous fluid flows out of the corresponding outlet opening 31, the gaseous fluid flowing out of the corresponding outlet opening 31 first flows through the passage opening of the corresponding passage section of the plate unit associated with the corresponding outlet opening 31 and then through the passage opening 35 of the corresponding passage section 33 of the film unit 23 associated with the corresponding outlet opening 31. The fact that the support unit 21, the film unit 23, and the plate unit are arranged relative to each other such that for each outlet opening 31, the corresponding outlet opening 31, a passage opening of the corresponding passage section of the plate unit associated with the corresponding outlet opening 31 and a passage opening 35 of the corresponding passage section 33 of the film unit 23 associated with the corresponding outlet opening 31 are arranged relative to each other such that, when the pressurized gaseous fluid flows out of the corresponding outlet opening 31, the gaseous fluid flowing out of the corresponding outlet opening 31 first flows through the passage opening of the corresponding passage section of the plate unit assigned to the corresponding outlet opening 31 and then through the passage opening 35 of the corresponding passage section 33 of the film unit 23 assigned to the corresponding outlet opening 31, ensures that the bearing unit 3 can have a plate unit and can be arranged so that the film unit 23 can be arranged on the side of the support unit 21 facing the flat belt section 15 and, in this arrangement, a bearing for guiding the belt unit 11 can be provided with the aid of the outlet openings, the passage openings, and the gaseous fluid, as well as with the aid of the film unit 23. In this case, the bearing unit 3 provides the two functions already described, and at the same time it can be ensured that the film unit 23 can be replaced particularly easily. In the alternative embodiment of the bearing unit 3 according to the invention, a corresponding passage opening 35 of a corresponding passage section 33 of the film unit 23 and a corresponding passage opening of a corresponding passage section of the plate unit are provided for each outlet opening 31.

In the embodiment of the bearing unit 3 according to the invention shown schematically in FIG. 2, the support unit 21 is made of a metal alloy, namely steel. The fact that the support unit 21 is made of a metal alloy provides a particularly robust support unit 21 in mechanical terms. The fact that the support unit 21 is made of steel means that the mechanical robustness of the support unit 21 is particularly optimal. In an alternative embodiment of the bearing unit 3 according to the invention, the support unit 21 is made of a metal, namely aluminum. Because the support unit 21 is made of aluminum, the support unit 21 can be designed to be particularly lightweight.

In the embodiment of the bearing unit 3 according to the invention shown schematically in FIG. 2, the film unit 23 comprises a fabric, namely a glass fabric, and a polymer, namely a fluoropolymer in the form of polytetrafluoroethylene (PTFE). Since the film unit 23 comprises a fabric, namely a glass fabric, and a polymer, namely a fluoropolymer in the form of polytetrafluoroethylene (PTFE), the film unit 23 provides a surface for contact with the belt unit 11, in particular with the flat belt section 15, wherein the surface comprises a low coefficient of friction with high abrasion resistance and high temperature resistance. The sections of the glass fabric are coated with the polytetrafluoroethylene (PTFE) such that the glass fabric provides mechanical robustness to the film unit 23, in particular within a plane in which the film unit 23 extends, and the polytetrafluoroethylene (PTFE) protects the glass fabric and provides the surface for contact with the belt unit 11, such that the surface can provide a particularly low coefficient of friction with high abrasion resistance and high temperature resistance.

The bearing unit 3 is arranged on a second side 19 of the flat belt section 15 opposing the first side 17 in such a way that the film unit 23 is arranged on a side of the support unit 21 facing the flat belt section 15. The fact that the bearing unit 3 is arranged on a second side 19 of the flat belt section 15 opposing the first side 17 in such a way that the film unit 23 is arranged on a side of the support unit 21 facing the flat belt section 15, it is ensured that the film unit 23 is provided for contact with the flat belt section 15 and that the film unit 23 protects the support unit 21 from contact with the flat belt section 15. Thus, the film unit 23 can be specifically designed for contact with the flat belt section 15, and if the film unit 23 wears out, the film unit 23 can be renewed or replaced and the support unit 21 can continue to be used, thereby providing a particularly resource-efficient bearing unit 3 and a particularly resource-efficient tire test bench 1.

The belt unit 11 is made of a metal alloy, namely steel, and can also be referred to as a steel belt. In particular, the belt unit 11 is made of steel. The fact that the belt unit 11 is made of steel ensures that the belt unit 11 is only slightly deformed under different load conditions of the tire 5. This means that tires 5 can be subjected to particularly high mechanical loads using the tire test bench 1.

When the flat belt section 15 is not loaded by a tire 5, the flat belt section 15 extends along a first plane. Even when the tire 5 loads the flat belt section 15 slightly, the first belt section 15 extends along the first plane. If the load on the first belt section 15 by the tire 5 continues to increase, the first belt section 15 is deformed in a direction toward the second side 19 of the flat belt section 15. As already described, the bearing unit 3 counteracts this deformation and thus prevents such deformation or at least reduces this deformation in contrast to a situation in which no bearing unit 3 is provided. The film unit 23 extends along a second plane which, in an installed state in which the bearing unit 3 is installed in the test bench 1, runs parallel to the first plane. Because the film unit 23 extends along the second plane, the film unit 23 provides a particularly flat surface for contact with the flat belt section 15, such that particularly strong deformation of the flat belt section 15 in a direction toward the bearing unit 3 can be counteracted by means of the surface of the film unit 23, wherein contact between the flat surface and the flat belt section 15 subjects the belt section 15 to particularly low mechanical stress. In the event that the plate unit is provided, the plate unit extends along a third plane that runs parallel to the second plane. The fact that the plate unit extends along the third plane, which runs parallel to the second plane, ensures that the plate unit forms a mechanically robust section to which the film unit 23 is connected and to which the film unit 23 can transfer forces acting on it through this contact when it comes into contact with the flat belt section 15. The support unit 21 extends along a fourth plane that runs parallel to the third plane and parallel to the second plane. The fact that the support unit 21 extends along a fourth plane that runs parallel to the third plane and parallel to the second plane ensures that the support unit 21 forms a mechanically robust section to which the film unit 23 is connected and to which the film unit 23 can transfer forces acting on the film unit 23 through this contact when the film unit 23 comes into contact with the flat belt section 15. In the event that the plate unit is provided, the support unit 21 forms a mechanically robust section to which the plate unit is connected and to which the plate unit can then, when the film unit 23 comes into contact with the flat belt section 15, divert forces acting on the plate unit due to this contact.

As already described, the embodiment of the bearing unit 3 according to the invention schematically shown in FIG. 2 exemplarily shows 130 outlet sections, 130 outlet openings, 130 passage sections, and 130 passage openings. The present invention is not limited to these specific numbers. Rather, other numbers are also comprised by the concept of the invention. For better clarification, each outlet section 29, each outlet opening 31, each passage section 33, and each passage opening 35 is a section in FIG. 2 enlarged and shown with a dashed border, in which an outlet section 29, an outlet opening 31, a passage section 33, and a passage opening 35 are shown. The two dashed lines arranged between the bearing unit 3 and the enlarged representation in FIG. 2 indicate the location where the exemplary section is arranged in the bearing unit 3.

As already described, FIG. 3 shows a schematic illustration of the embodiment of the method according to the invention for manufacturing the embodiment of the bearing unit 3 according to the invention schematically shown in FIG. 2. In a first method step 101 of the method, the support unit 21 is provided. In a second method step 102 of the method, passage openings are made in the film unit 23. In a third method step 103 of the method, the film unit 23 is glued to the support unit 21. Gluing the film unit 23 to the support unit 21 ensures that the bearing unit 3 can be manufactured particularly easily and quickly and that the film unit 23 can be replaced particularly easily.

In the third method step 103 of the method, the film unit 23 is glued to the support unit 21 such that the support unit 21 and the film unit 23 are arranged relative to each other such that, for each outlet opening 31, the corresponding outlet opening 31 and a passage opening 35 associated with the corresponding outlet opening 31 are arranged relative to each other such that, when the pressurized gaseous fluid flows out of the corresponding outlet opening 31, the gaseous fluid flowing out of the corresponding outlet opening 31 flows through the passage opening 35 assigned to the corresponding outlet opening 31.

The method can therefore be used to produce the bearing unit 3. In the method, the support unit 21 and the film unit 23 are provided such that the support unit 21 and the film unit 23 are arranged relative to each other in such a way that, for each outlet opening 31, the corresponding outlet opening 31 and a passage opening 35 associated with the corresponding outlet opening 31 are arranged relative to each other such that when the pressurized gaseous fluid flows out of the corresponding outlet opening 31, the gaseous fluid flowing out of the corresponding outlet opening 31 flows through the passage opening 35 associated with the corresponding outlet opening 31. The fact that the support unit 21 and the film unit 23 are arranged relative to each other such that for each outlet opening 31, the corresponding outlet opening 31 and a passage opening 35 assigned to the corresponding outlet opening 31 are arranged relative to each other such that, when the pressurized gaseous fluid flows out of the corresponding outlet opening 31, the gaseous fluid flowing out of the corresponding outlet opening 31 flows through the passage opening 35 associated with the corresponding outlet opening 31, ensures that the bearing unit 3 can be arranged so that the film unit 23 can be arranged on a side of the support unit 21 facing the flat belt section 15 and that the bearing unit 3 can be arranged such that, in this arrangement, a bearing for guiding the belt unit 11 can be provided with the aid of the outlet openings, the passage openings, and the gaseous fluid, as well as with the aid of the film unit 23. The bearing unit 3 provides the two functions already described.

Even though the method steps are described in a specific order, the present invention is not limited to this order. Rather, the individual method steps can be carried out in any sensible order, in particular also at least in sections parallel to each other in time.

It should also be noted that “comprising” does not exclude other elements or steps, and “one” does not exclude a plurality. It should also be noted that features described with reference to one of the above exemplary embodiments may also be used in combination with other features of other exemplary embodiments described above. Reference numbers in the claims are not to be construed as limitations.

### Reference Numbers

1 tire test bench
3 bearing unit
5 tires
7 tread
9 axis of rotation
11 belt unit
13 pulley
15 flat belt section
17 first side of flat belt section
19 second side of flat belt section
21 support unit
23 film unit
25 inlet section
27 inlet opening
29 outlet section
31 outlet opening
33 passage section
35 passage opening of a passage section of the film unit
101 first method step
102 second method step
103 third method step

1-10. (canceled)

11. A bearing unit (3) for a tire test bench (1), comprising:
a support unit (21) having an inlet section (25) defining an inlet opening (27) and a plurality of outlet sections, wherein each outlet section (29) of the plurality of outlet sections defines an outlet opening (31), wherein each outlet opening (31) is connected to the inlet opening (27) such that, when a pressurized gaseous fluid flows into the inlet opening (27), the pressurized gaseous fluid flows out of each outlet opening (31); and
a film unit (23) having a plurality of passage sections, each passage section (33) of the plurality of passage sections defining a passage opening (35);
wherein the support unit (21) and the film unit (23) are arranged relative to each other such that, for each outlet opening (31), the corresponding outlet opening (31) and a passage opening (35) associated with the corresponding outlet opening (31) are arranged relative to each other such that, when the pressurized gaseous fluid flows out of the corresponding outlet opening (31), the gaseous fluid flowing out of the corresponding outlet opening (31) flows through the passage opening (35) associated with the corresponding outlet opening (31).

12. The bearing unit (3) according to claim 11, wherein the support unit (21) and the film unit (23) are connected to each other.

13. The bearing unit (3) according to claim 11, comprising a plate unit between the support unit (21) and the film unit (23), wherein the plate unit and the film unit (23) are connected to each other.

14. The bearing unit (3) according to claim 11, wherein the support unit (21) comprises a metal or a metal alloy.

15. The bearing unit (3) according to claim 11, wherein the film unit (23) comprises a fabric.

16. The bearing unit (3) according to claim 11, wherein the film unit (23) comprises a polymer.

17. A method for manufacturing the bearing unit of claim 11, comprising:
providing the support unit (21) and the film unit (23); and
arranging the support unit (21) and the film unit (23) relative to each other such that, for each outlet opening (31), the corresponding outlet opening (31) and a passage opening (35) associated with the corresponding outlet opening (31) are arranged relative to each other such that, when the pressurized gaseous fluid flows out of the corresponding outlet opening (31), the gaseous fluid flowing out of the corresponding outlet opening (31) flows through the passage opening (35) associated with the corresponding outlet opening (31).

18. The method according to claim 17, comprising:
gluing the film unit (23) to the support unit (21).

19. A tire test bench (1)
a frame;
a tire holder attached to the frame, on which a tire (5) having a tread (7) can be mounted so that it can rotate about its axis of rotation (9);
a belt unit (11); and
two pulleys rotatably mounted relative to the frame, wherein the two pulleys are partially wrapped by the belt unit (11) such that the belt unit (11) forms a flat belt section (15) between the pulleys;
wherein, when the tire (5) is rotatably mounted on the tire holder, the tire (5) can be moved on a first side (17) of the flat belt section (15) into a contact position in which the tread (7) of the tire (5) and the flat belt section (15) are in contact, and
wherein, when the tire (5) and the flat belt section (15) are in contact and the belt unit (11) is moved relative to the tire (5), the tire (5) rolls on the flat belt section

(15) ; and
the bearing unit (3) according to claim 11, wherein the bearing unit (3) is arranged on a second side (19) of the flat belt section (15) opposing the first side (17) such that the film unit (23) is arranged on a side of the support unit (21) facing the flat belt section (15).

20. The tire test bench (1) according to claim 19, wherein the belt unit (11) comprises a metal or a metal alloy.
